(19) United States
(12) Patent Application Publication
(10) Pub. No.: US 2013/0333847 A1
(43) Pub. Date: Dec. 19, 2013

(54) DOOR WITH RETRACTABLE SCREEN

(71) Applicant: LARSON MANUFACTURING COMPANY OF SOUTH DAKOTA, INC., Brookings, SD (US)

(72) Inventors: Paul Casseri, Brookings, SD (US); Henry Hitt, Sioux Falls, SD (US); Alan M. Dixon, Brookings, SD (US)

(73) Assignee: Larson Manufacturing Company of South Dakota, Inc., Brookings, SD (US)

(21) Appl. No.: 13/865,024

(22) Filed: Apr. 17, 2013

Related U.S. Application Data
(60) Provisional application No. 61/661,220, filed on Jun. 18, 2012.

(51) Int. Cl. E06B 9/24

(52) U.S. Cl. CPC E06B 9/24
USPC 160/90; 160/371; 160/87

(57) ABSTRACT

A door system including a door frame with first and second sides spaced from each other across a width of the frame, top and bottom edges spaced from each other across a height of the frame, and a central opening, and a retractable screen member movable from the first toward the second side of the frame or from the top to the bottom edges of the frame, wherein the screen member includes a cassette and a flexible screen member that is retractable and extendable relative to the cassette.

### CROSS-REFERENCE TO RELATED APPLICATIONS

The present application claims priority to U.S. Provisional Application No. 61/625,535, filed Apr. 17, 2012, and U.S. Provisional Application No. 61/661,220, filed Jun. 18, 2012, the contents of which are incorporated herein by reference in their entireties.

### TECHNICAL FIELD

The present invention relates generally to doors, and more specifically relates to a door that includes both glass and screen portions that allow for controlled adjustment of ventilation.

### BACKGROUND

Doors that incorporate both glass and screens into a single door system are known, and are generally provided to allow the user to choose whether to use the door in a manner in which the door does not provide any ventilation or in a manner where a removable or reconfigurable screen allows for at least some ventilation. For one example, storm doors are provided with separate glass and screen panels that are interchangeable by removal and replacement of these panels to provide a desired function to the door. For another example, hinged doors, sliding doors, and primary windows are commercially available that include a retractable screen that is mounted across the frame of the door or window. Further, storm doors are commercially available that include a vertically-operating retractable screen that is mounted within a panel of the storm door. In one specific example of such doors, storm doors are provided with a stationary pane of glass and a second pane of glass that is vertically mounted and moveable relative to the stationary pane. The moveable pane of glass typically slides along one or more rails or tracks in such a way that it simultaneously overlaps at least a portion of the stationary pane of glass while exposing or extending a retractable screen. In this way, a single door can provide both ventilation and protection without the inconvenience of removing and interchanging glass panels and screen panels. There is a desire, however, to provide additional options for consumers by providing full-view doors that have a retractable screen that does not require multiple pieces of stationary/moveable glass and/or that does not require switching between screen and glass panels when it is desired to provide ventilation through at least a portion of the door opening. Such a door would provide a clear, unobstructed viewing area with the convenience of a screen that stores within the door.

### SUMMARY

In accordance with an embodiment of the invention, a door system is provided that includes a retractable screen member. The screen member can be retracted so that it is stored within the door itself, so that the door system eliminates the need for a user to store a flat screen when it is not in use. The door system of the invention can be provided with a variety of different screen type materials to customize the performance and features of the door. For example, the retractable screen used can help to control the amount of solar heat build-up that occurs between a storm door and a prime door, while additionally or alternatively providing ventilation, insect control, and privacy. The retractable screen can also be moved out of a user's line of vision to advantageously provide a more clear or unobstructed view when the screen is not needed or desired.

In accordance with an aspect of the invention, a door system is provided that allows for partial ventilation without having to remove or replace any panels and/or components. In this embodiment, a width of screen material extends from an edge of a glass panel or from a support member that is attached to the glass panel. It is understood that other materials, such as polycarbonate, Lexan, clear laminates, and clear films may be used in place of glass. The width of the screen material is equal to or smaller than a width of a section of the doorframe into which it can be stored when it is not desired to have ventilation through the central door opening. With this embodiment, the glass panel can be slid or shifted in a direction that pulls or shifts the screen from its storage position to a position in which the screen is exposed within the central door opening. In this position, the exposed section of screen will provide partial ventilation through the door.

### BRIEF DESCRIPTION OF THE DRAWINGS

The present invention will be further explained with reference to the appended Figures, wherein like structure is referred to by like numerals throughout the several views, and wherein:

FIG. 1 is a perspective view of an embodiment of a door of the invention;

FIG. 2 is a partial cross-sectional side view of a portion of the door illustrated in FIG. 1, including a portion of a screen cassette;

FIG. 3 is a partial cross-sectional top view of a portion of the door illustrated in FIG. 1, including a portion of a screen cassette;

FIG. 4 is a partial cross-sectional view of a portion of the door illustrated in FIG. 1;

FIG. 5 is a front view of a door of the invention with a retractable screen in its fully retracted position;

FIG. 6 is a front view of a door of the invention with a retractable screen in a partially extended position;

FIG. 7 is a front view of a door of the invention with a retractable screen in a fully extended position;

FIG. 8 is a cross-sectional view of an embodiment of a portion of a door system of the invention;

FIG. 9 is a perspective view of an embodiment of a door system of the invention;

FIG. 10 is a front view of a door system of the invention, with its screen in a retracted position;

FIG. 11 is a front view of a door system illustrated in FIG. 10, with its screen in the extended or exposed position;

FIG. 12 is a cross-sectional view of the head section of a door frame;

FIG. 13 is a partial top and partial cross-sectional view of the latch side of a door frame;

FIG. 14 is a partial top and partial cross-sectional view of the screen side of a door frame;

FIG. 15 is a cross-sectional top view of the hinge side of a door with the sash in a closed and locked position;

FIG. 16 is a cross-sectional top view of the door portion illustrated in FIG. 15, with the sash in an open position;

FIG. 17 is a cross-sectional view of the latch side of a door with the sash in an open position;

FIG. 18 is a cross-sectional top view of the latch side of a door with the sash in a closed position;

FIG. 19 is a cross-sectional side view of the head of a door of the invention;

FIG. 20 is a cross-sectional side view of the sill of a door of the invention;

FIG. 21 is a perspective view of a portion of a door sill;

FIG. 22 is another perspective view of a portion of a door sill;

FIG. 23 is a perspective view of a portion of a door sill;

FIG. 24 is a cross sectional side view of the door sill of FIG. 23 with a glass or other panel positioned thereon; and

FIG. 25 is a front view of an embodiment of a door system of the invention.

### DETAILED DESCRIPTION

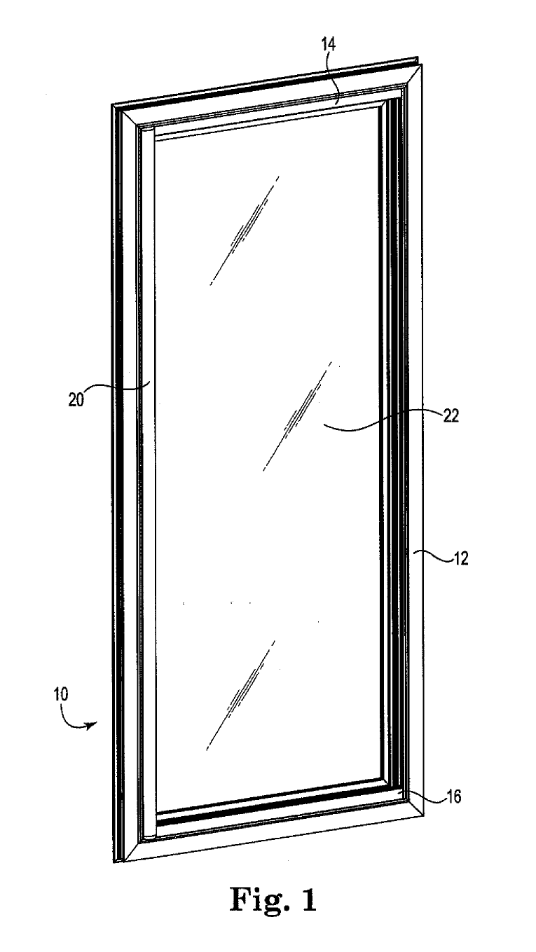

Referring now to the Figures, wherein the components are labeled with like numerals throughout the several Figures, and initially to FIG. 1, one exemplary configuration of a door system 10 is illustrated, which generally includes a door frame 12, a top track 14 positioned at the upper area of frame 12, and a bottom track 16 positioned at the lower area of frame 12. In this embodiment, the door system 10 is illustrated as a “full-view” type of door, which is referred to herein as a door that generally provides the largest opening or viewing area possible for a user by maximizing the amount of open area for a door while maintaining the structural integrity of the door. It is understood, however, that the devices and systems of the invention are not limited to be used with doors that are considered to be “full-view” doors, but can also be used for doors that can be considered to be classified as “partial-view” doors, for windows, or for other building construction configurations.

Door system 10 further includes a vertically-mounted, horizontally-operating retractable screen 20, which is moveable (e.g., extendable and retractable) relative to the width of the door. The retractable screen 20 can be positioned on either side of the door frame 12, and in one example, the door system includes a hinged door, and the screen 20 can be positioned either on the hinged side of the door or on the latch side of the door. In this exemplary embodiment, the door system 10 can include a glass panel 22 that can be either permanently or removably secured to the doorframe 12. The screen 20 can be extended across the width of the door frame 12, which may be used to reduce heat build-up between the door system 10 and a primary entry door that can be caused by solar heat gain (i.e., direct or indirect exposure of the door to the sun), such as if the door system 10 is used as a storm door. It is also contemplated that a user may extend the screen 20 across all or part of the width of the door to provide an optional additional visual barrier in situations where the user desires more privacy, and then can retract the screen when it is desired to have a more unobstructed view through the glass panel of the door. In one embodiment of the invention, the glass can be completely removed such that retraction and extension of the retractable screen 20 will provide a door opening that is entirely uncovered or that is at least partially covered only by a screen, as desired. In an alternate configuration of the door system of FIG. 1, the screen can be mounted in a horizontal configuration such that operation of the screen will be performed by moving the screen vertically.

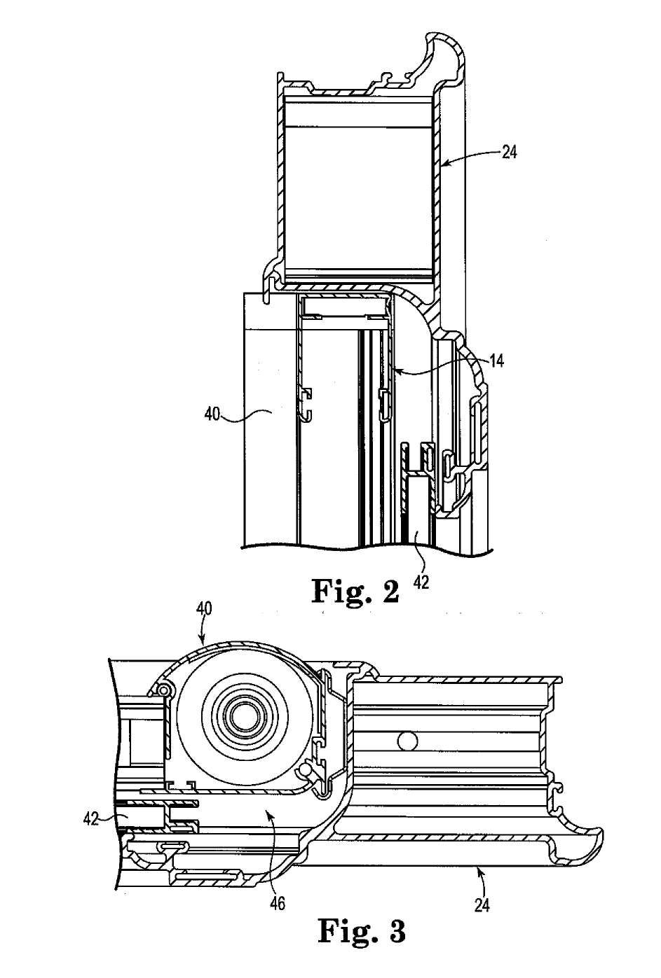

FIG. 2 illustrates a partial cross-sectional side view of a portion of the door system 10 illustrated in FIG. 1, including a portion of a screen cassette 40, wherein the outside of the door frame 12 is designated by reference numeral 24. Screen cassette 40 is configured for containing a length of screen material that is sufficient to cover at least a portion of the width of the opening of the door frame 12. The tracks 14, 16 are designed to contain or support the edges of screen material that extends from the cassette 40 and to guide a pull rail of the screen. As is further illustrated in FIG. 2, a glass sash or glass panel 42 is located on one side of the retractable screen, which allows the screen to be extended across the glass as a shade when the glass is installed. If the glass is removed from the door, the screen can be extended across the opening of the door to provide ventilation, privacy, and to keep insects from entering through the door opening.

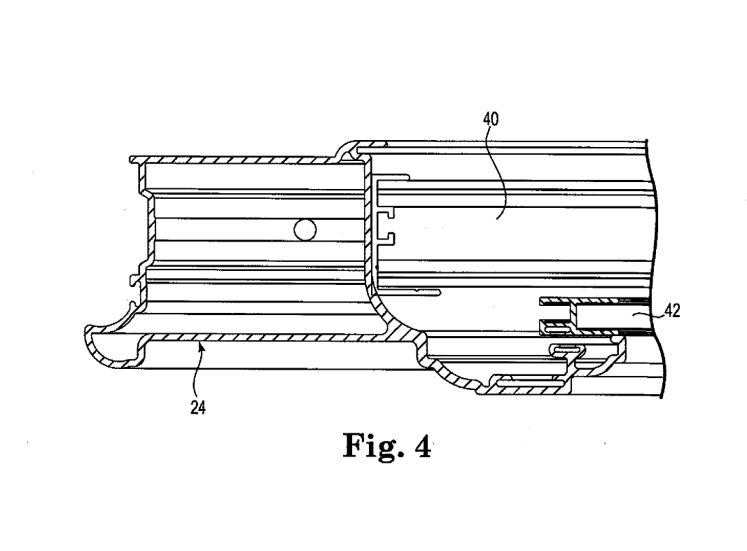

FIG. 3 illustrates an edge of glass panel 42 positioned in a pocket 46 that is either created by the screen cassette 40 or by the shape of the door frame itself. In this embodiment, a full-length retainer is therefore optional on that side of the glass panel 42. FIG. 4 further illustrates the glass panel 42 and cassette 40 in another configuration in which the glass can move to the left (with respect to the illustration) to remove the glass panel from the pocket 46 located on the opposite side of the door frame and allow the glass panel to come out of the door. Once the glass panel is removed, the screen can be pulled across the opening in the manner described above.

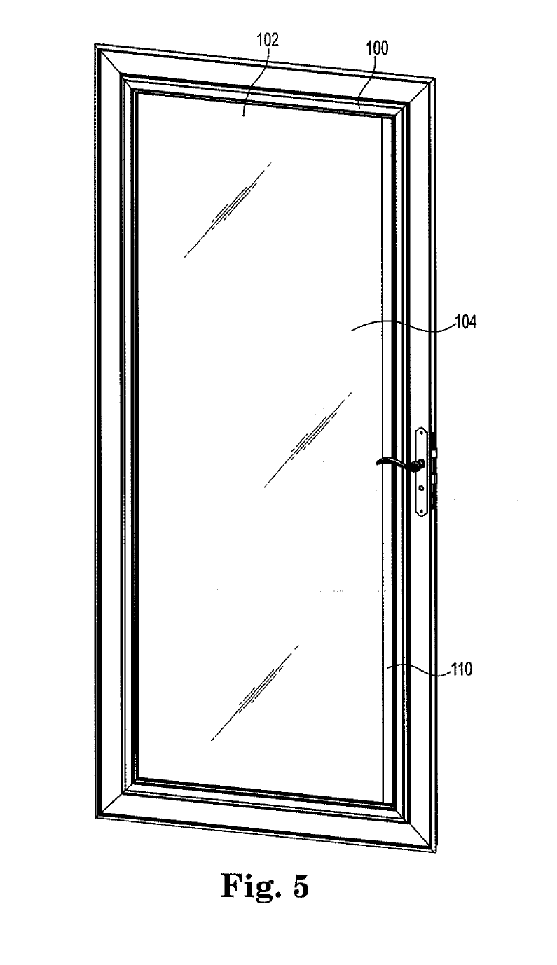

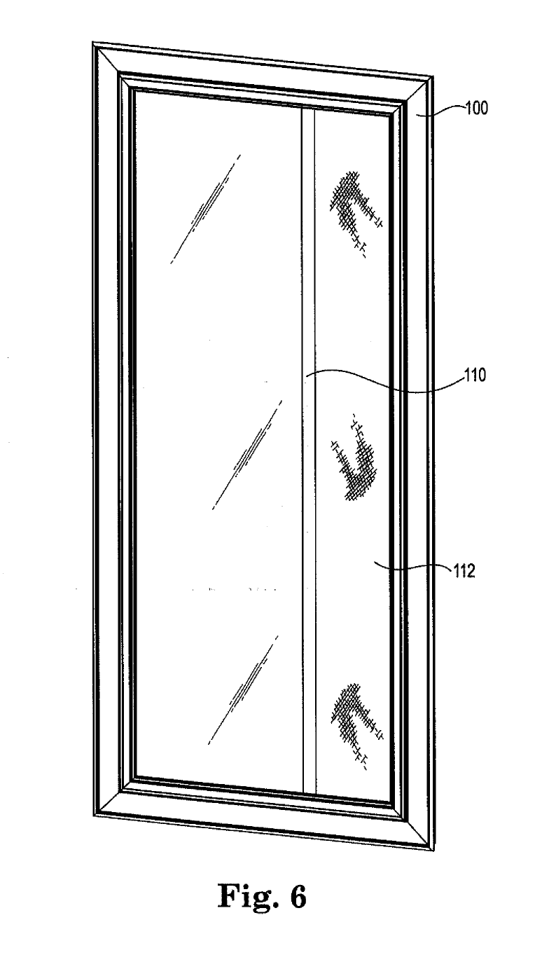

Referring now to FIGS. 5-7, a door system is illustrated that includes a door frame 100 with a central opening 102. A glass panel 104 is positioned relative to frame 100 and opening 102, along with a retractable screen system that includes a pull rail 110 and a screen material 112. This illustrated door system can include any or all of the features described above relative to FIGS. 1-4, for example, or can include additional or different features. FIG. 5 illustrates the door system 100 with the glass 104 positioned to extend across the central opening 102 of the door frame 100 and the pull rail 110 located adjacent to a door jamb when the screen 112 (not visible in this figure) is in a retracted position. FIG. 6 illustrates the pull rail 110 moved from its retracted position of FIG. 5 and across a portion of the width of the central opening 102, causing the screen 112 to be partially extended from the cassette to cover a corresponding portion of the opening and the glass. FIG. 7 illustrates the pull rail 110 as it has been moved across the entire width of the central door opening as compared to the partially extended position of FIG. 6, causing the screen to be further extended from the cassette to cover the remaining portion of the opening and glass. The pull rail 110 will then be located on the opposite side of the door frame from when it is in its retracted position (i.e., the opposite side from the door jamb 105). Moving the pull rail 110 back toward the opposite side will cause the screen to retract into the cassette by a corresponding amount.

In accordance with the embodiments described herein, the retractable screen can be provided on either the interior or exterior side of the glass. That is, it may be desirable in at least some embodiments for the screen to be positioned on the interior side of the glass so that a user inside the building or room can easily access the screen without having to move to the other side of the door. However, in other aspects of the invention, it may be desirable for the screen 20 to be positioned on the exterior side of the glass so that a user would retract and extend the screen from the outside of the building or room. It is further contemplated that although the illustrated embodiments are directed generally to horizontal operation of a vertically-mounted screen, the invention also contemplates mounting of the screen in a horizontal configuration such that operation of the screen will be performed by moving the screen vertically.

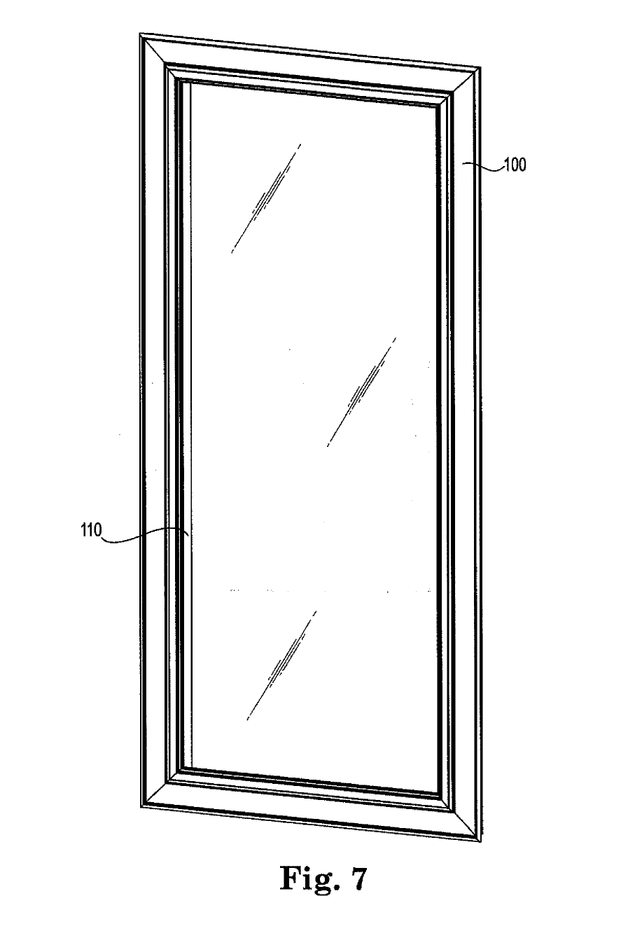

FIG. 8 is a cross-sectional view of a portion of a door system 120 that includes a screen material 124 that is retractable and extendable relative to a spring-loaded cassette 126. According to this embodiment, a glass panel 122 would not need to be removed for ventilation, but can remain attached to a door frame 128, such as in a hinged relationship. In this way, the window can be opened to provide ventilation without having to remove the glass. As is illustrated in the figure, the door system includes glass panel 122, door frame 128, screen roll or cassette 126, and a glass panel frame 130, which components can be interchanged with components described above relative to door system 10, as desired. The hinge may be formed from aluminum, for example, or can be constructed from other materials, such as plastic, to form a living hinge. Alternatively, the hinge can be a concealed piano hinge or can be a ball and socket type of connection between the frame and sash. The glass can either be built into the pivoting glass panel frame or glazed directly to it.

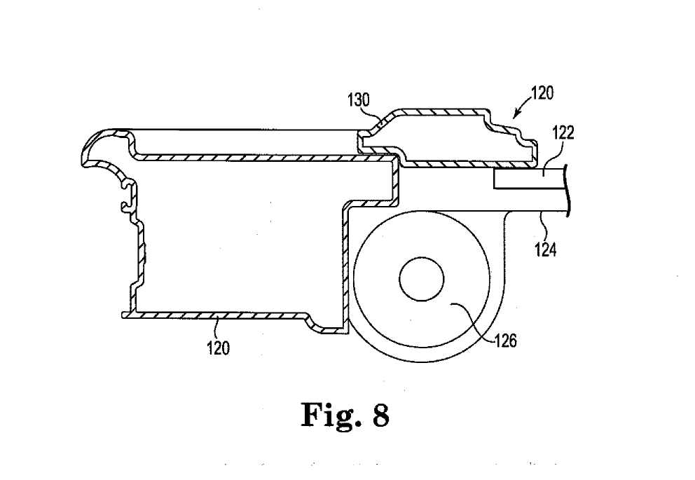

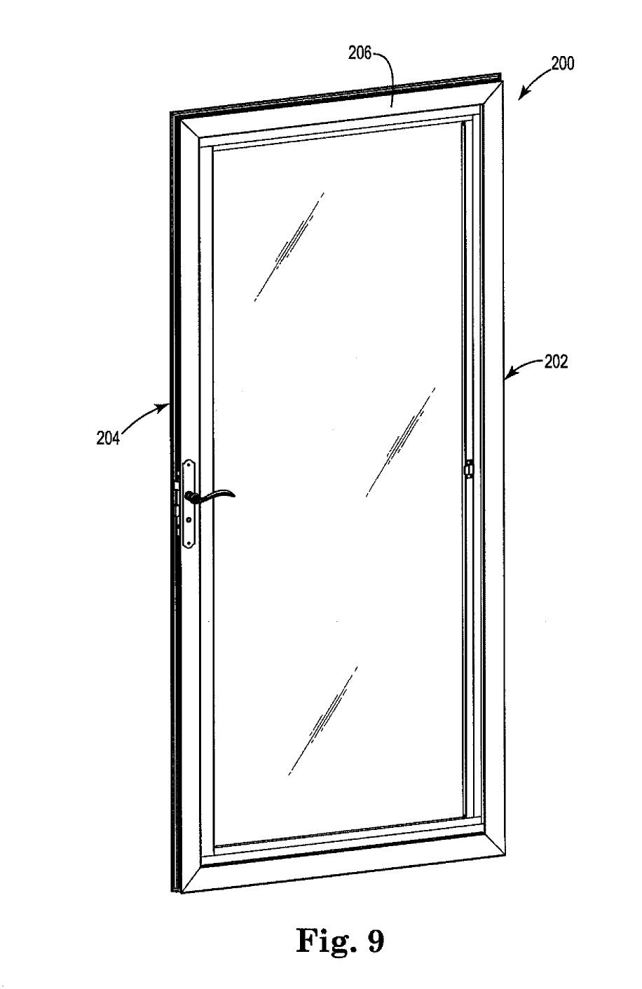

In another aspect of the invention, which is illustrated in FIGS. 9-22, a glass panel may be permanently mounted relative to a retractable or concealable screen in such a way that the glass can be slid horizontally toward one of the sides of the door to expose a small section of the width of the screen. In this way, some ventilation can be provided through the central door opening via a small manipulation of the system, while eliminating the need for a user to completely remove the glass from the door system. In such a system, the edge of the screen can be attached directly to the glass or to a frame member that is attached to the glass. Such a screen can then be moved out of the line of vision to provide an unobstructed view when the screen is not needed or desired and also to block movement of air through the central door opening. In addition, this door embodiment can be considered to be self-storing without needing a center horizontal mullion at the meeting rail, as is typical for other self-storing fullview doors.

FIG. 9 illustrates an interior view of an embodiment of a fullview door system 200 that includes a door frame 206 having a hinge side 202 and a latch or handle side 204. The door frame 206 further includes a track in its top and bottom sides that can contain a screen panel and a glass panel. It is noted that while much of the description provided for this door embodiment is directed to the screen being positioned at the hinge side 202 of the door frame 206, it is understood that the screen can instead be positioned at the latch side 204 of the door frame 206, if desired. In addition, it is contemplated that the entire door frame 206 can be rotated 180 degrees in order to accommodate left and right hand door hinge configurations.

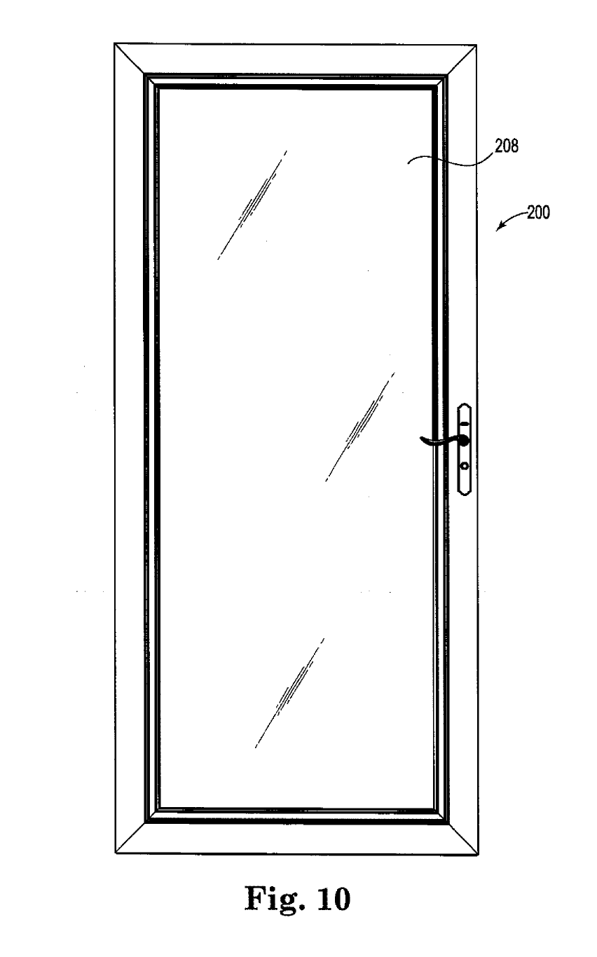

FIGS. 10 and 11 show the exterior side of door system 200, where FIG. 10 shows the opening of the door filled with only a glass panel 208, with the screen in its stored or retracted position. FIG. 11 shows a screen panel 210 in its extended or exposed position, with a portion of the glass panel 208 being positioned within the door frame on latch side 204. Although a wide variety of screen materials can be used for the screens of this door system 200, it is contemplated that the screen panel be made of a relatively rigid material that moves easily relative to the tracks that guide the screen panel between its extended and retracted positions.

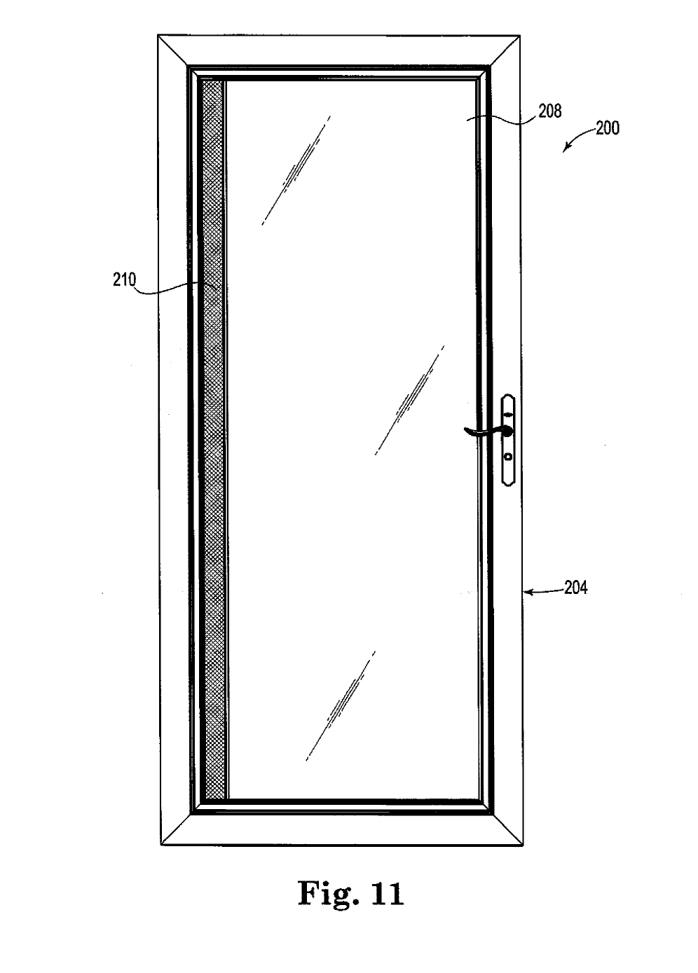

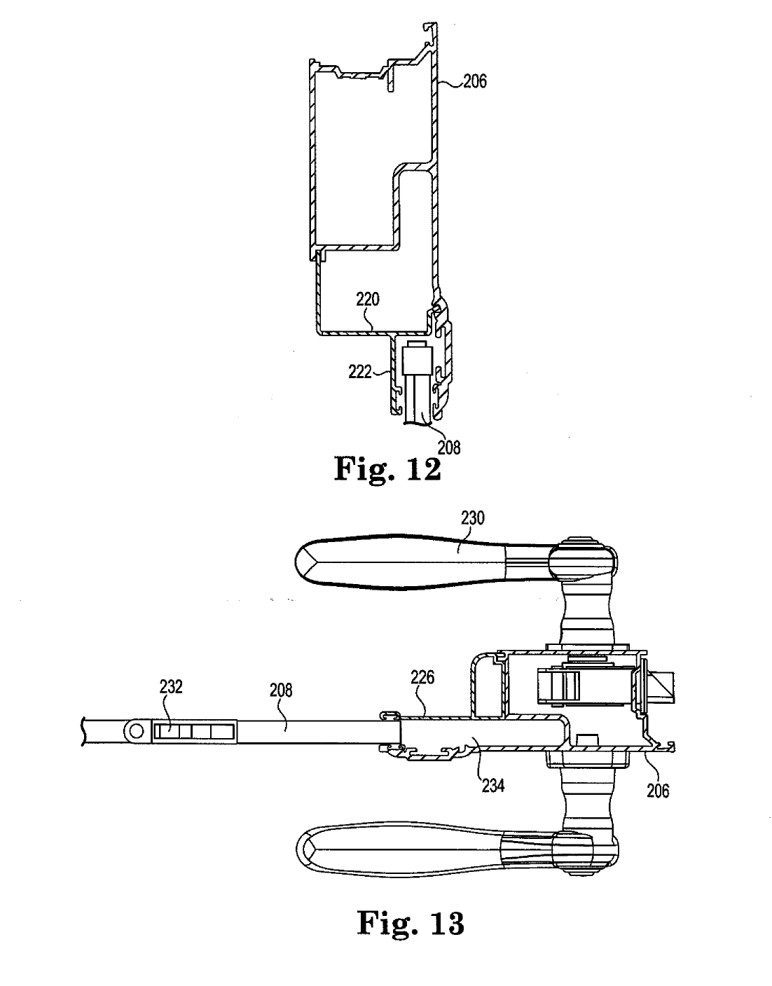

Referring now to FIG. 12, a cross-sectional view of a portion of the door frame 206 with a track member 220 is shown. Track member 220 is provided both at the top and bottom of the door frame 206 in order to contain and guide the glass panel 208 and the screen panel 210. As shown in this Figure, the door frame 206 has a number of contours and sections that are intended to illustrate one exemplary configuration for the door frame, although other door frame configurations are considered to be within the scope of the invention. In any case, a space is provided between the door frame 206 and an extending member 222 of the track member 220 in order to contain and guide the glass and screen panels.

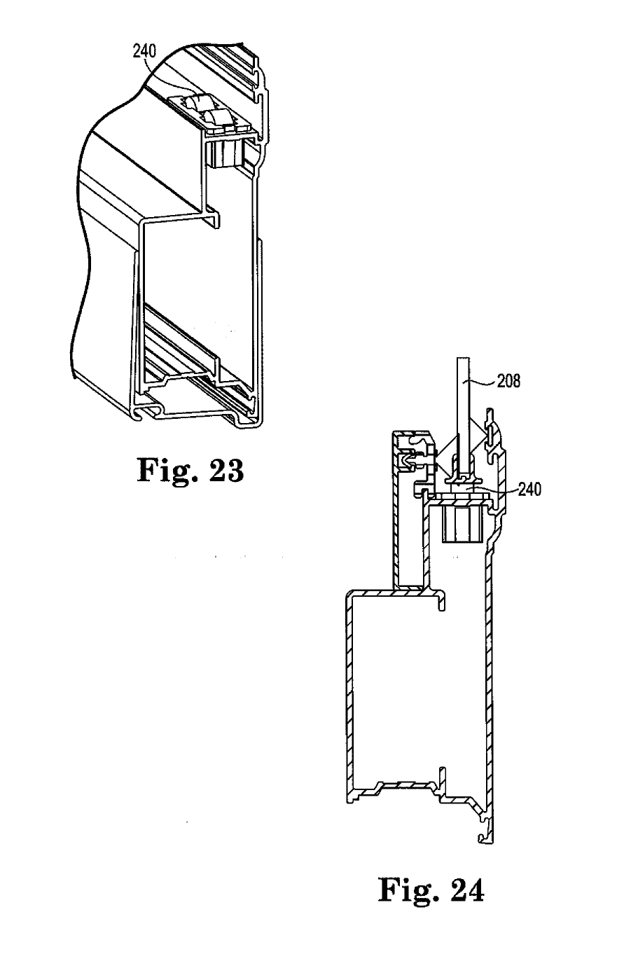

FIG. 13 is a cross-sectional view taken in the area of a door handle assembly 230, which may include any number of door handle types and assemblies. The exemplary door handle assembly 230 is attached to the door frame 206 in this area using conventional techniques and components for handle and lockset applications. The track member 226 is positioned relative to the door frame 206 so that a pocket 234 is provided to accept the glass panel 208 when it is moved toward the handle. As shown, in order to facilitate smooth movement of the glass panel 208, one or more roller assemblies 232 can optionally be provided along the edges of the glass panel 208, although other devices and/or configurations can instead be provided to facilitate smooth movement of the components relative to each other. These rollers or other devices can alternatively or additionally be provided on the frame members so that the glass panel can be moved across the rollers, as shown in FIGS. 23 and 24, for example. As shown in these Figures, The depth of the pocket 234 corresponds to the amount of movement available for the glass and screen panel assembly. That is, the amount that the glass panel 208 can be shifted into this pocket 234 corresponds with the amount of the screen panel 210 that will be exposed on the opposite side of the door (i.e., at the hinge side, in this embodiment).

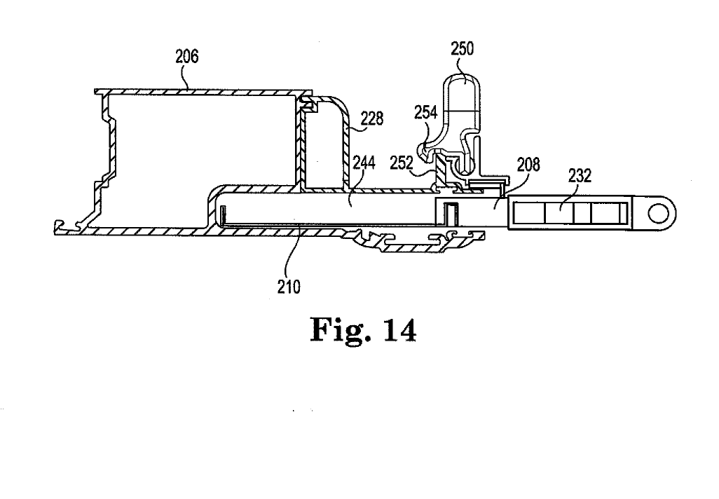

FIG. 14 provides a view of the area of the door system 200 taken at the opposite side of the door from the illustration of FIG. 13. As shown, a pocket 244 is created between the door frame 206 and the track member 228, into which the screen panel 210 can be retracted, as is shown in this figure. The screen panel can be made of aluminum, steel, or fiberglass, for example, and can be provided in a pleated or non-pleated configuration. The screen panel 210 extends from an edge of the glass panel 208, which can include rollers 232, as described above relative to other glass panels of the invention. In addition, the door system 200 includes a handle 250 that can be used for latching or securing the glass panel 208 in its closed position (i.e., with the screen panel 210 in its stored or retracted location within the pocket 244). This handle 250 includes a flange 254 that is engageable with a pin 252 that maintains the components in this closed position. In order to move the screen panel 210 to an extended position, the handle 250 is disengaged from the pin 252, such as by slightly rotating or pulling the handle, and the glass panel can then be moved toward the opposite side of the door frame. The handle 250 can be positioned in any desired position relative to the perimeter of the glass panel 208, although it is preferable that it is located in a position that is easily accessible for manipulation by a user.

In the illustrated embodiment, the handle 250 provides for both the latching or locking function for the system and also facilitates the movement of the glass panel relative to the door frame. However, the system may instead include a latch that is manipulated to unlock the glass panel from the door frame and a separate handle or other component that can be grasped or otherwise manipulated by the user to move the glass panel after it has been unlocked or unlatched from the door frame.

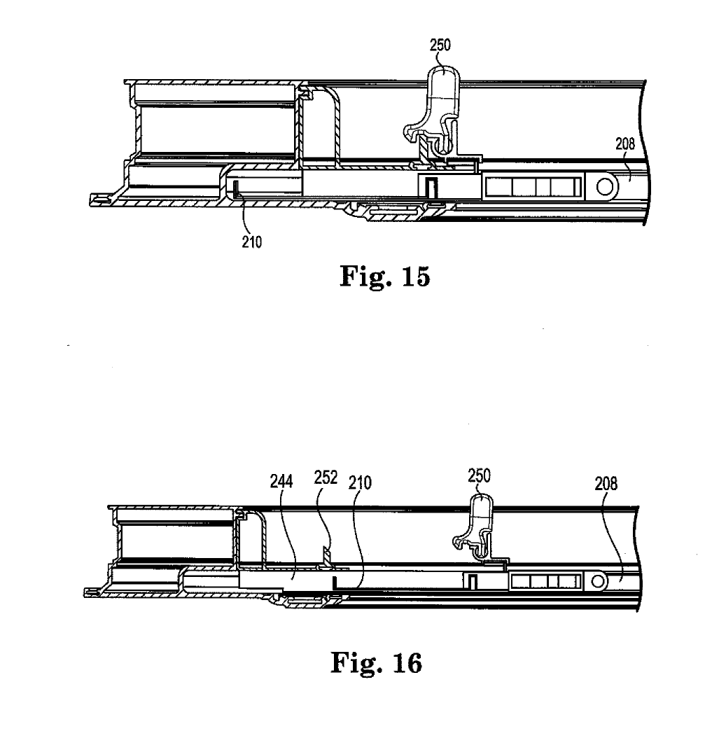

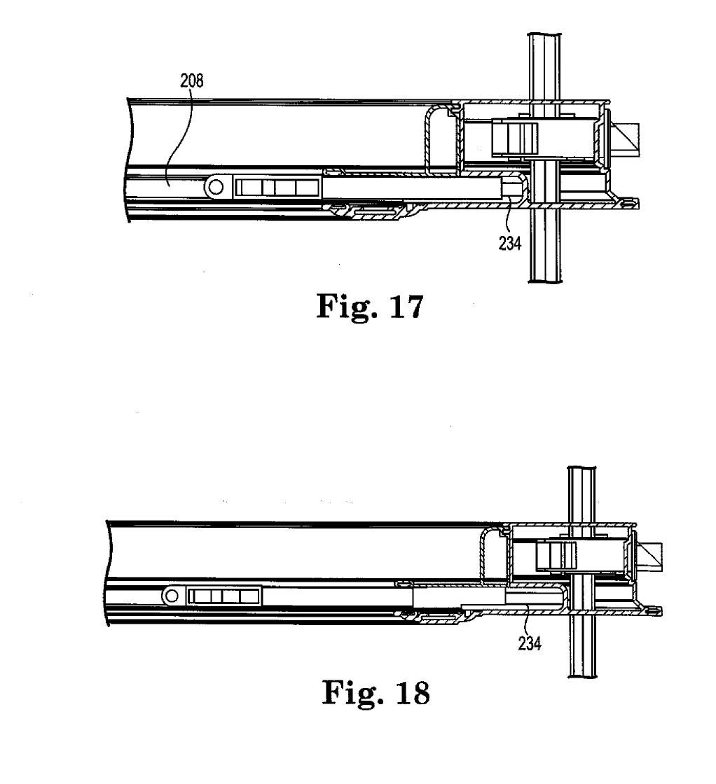

FIGS. 15-18 provide additional illustrations of a door system of the invention, where FIGS. 15 and 18 show the glass panel in a closed configuration and FIGS. 16 and 17 show the glass panel in an open configuration. In order to move the glass panel from its closed position of FIG. 15 to its open position of FIG. 16, the handle/latch mechanism 250 is disengaged from pin 252 and therefore is capable of sliding toward the opposite side of the door frame. As can also be seen in FIG. 16, when the glass panel 208 is moved to the right, the screen panel 210 is moved from the pocket 244, where it will be exposed in the central opening of the door frame. Similarly, when the glass panel is moved from its closed position of FIG. 18 to its open position of FIG. 17, the glass panel 208 is moved into the pocket 234 by the same distance that the screen panel is moved from its pocket 244.

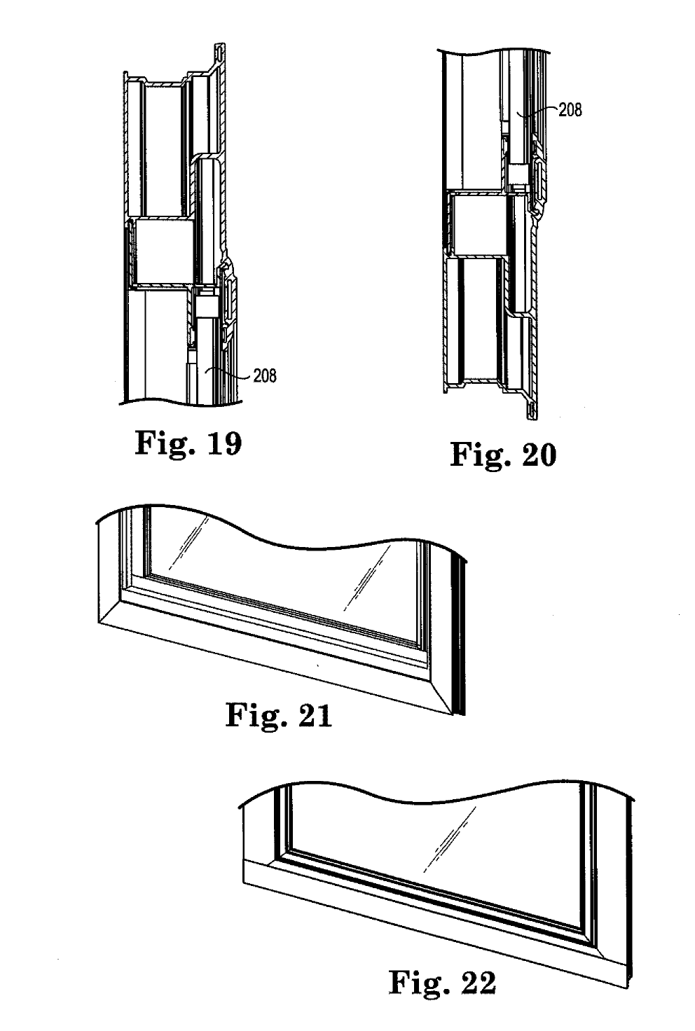

FIGS. 19-22 provide additional views of the head and sill of the door system 200 of the invention, with the glass panel 208 positioned therein. In particular, FIG. 19 is a cross-sectional view of a head of a door, FIG. 20 is a cross-sectional view of a sill of a door, and FIGS. 21 and 22 are interior and exterior views of a door sill, respectively. This configuration can be varied to accommodate the size and shape of the glass panel provided with the system.

In an alternative embodiment, the screen may be positioned to the interior side of the glass or to the exterior side of the glass. In another alternative embodiment, the screen portion can be positioned at the top or bottom of the door, so that movement of the glass will be in a vertical direction in order to expose and store a screen member. In yet another alternative embodiment, screen sections may extend from more than one edge of the glass on a single door, such as from both vertical edges of the glass, from both horizontal edges of the glass, or from both horizontal and vertical edges of the glass, for example. In these alternative embodiments, the frame structure would be modified to provide the desired movement of the screen and glass combination relative to the doorframe.

In another embodiment, the screen may not be only a rigid screen panel, but instead can comprise a screen member that is pleated or has a pleated section, which may allow for a larger screen opening for a particular door. In such an embodiment, the screen movement is similar to that described above, but the pockets provided in the door frame will additionally need to accommodate a thickness of the screen pleats.

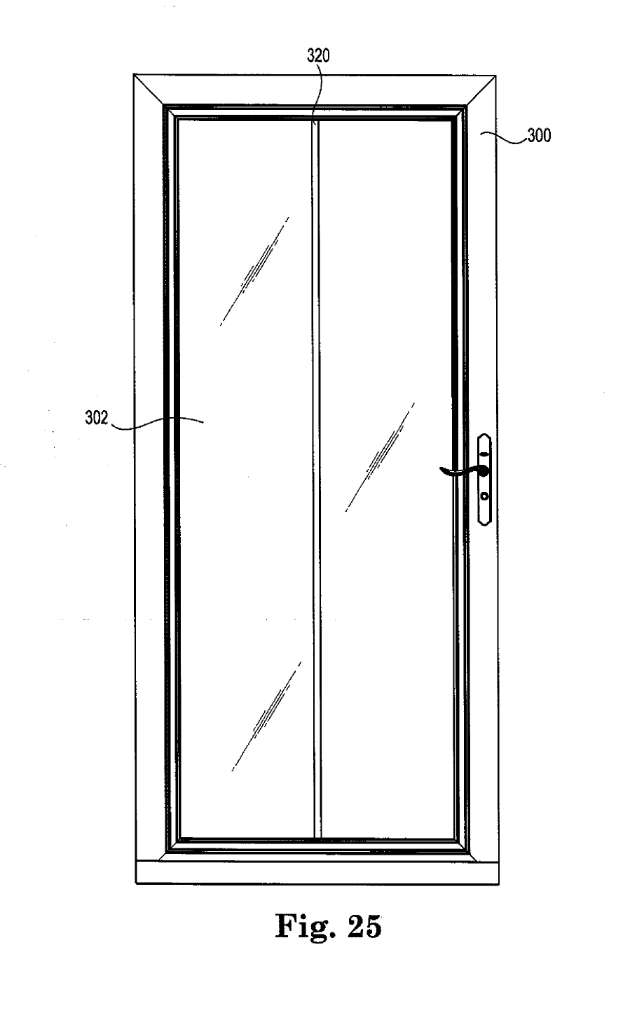

A door system is illustrated in FIG. 25, which includes a door frame 300 with a central opening 302. Two retractable cassette assemblies are provided on opposite sides of the door (i.e., either on the top and bottom or on the hinge and latch sides of the door frame 300). FIG. 25 illustrates the configuration where the cassette assemblies are located on opposite sides of the opening; however, this description also applies to the configuration where the cassette assemblies are located on the top and bottom of the opening. In either case, one of the two cassettes includes a roll of screen-type material, while the other cassette includes a roll of transparent or semi-transparent flexible film. Both the screen material and the transparent film have are coiled or folded (e.g. accordion-folded) within their respective cassettes, and each material has an end that is extendible from the cassette. These ends of the screen material and the transparent material are attached to a pull rail 320 that is moveable relative to the opening, and functions to join the two materials to a common structural component, and also to provide a handle that a user can grasp to adjust the location of the rail relative to the opening. In particular, the rail 320 can be slid side-to-side (or up and down) to adjust the ratio of the screen material and clear film in the opening, as desired. Each of the cassettes include springs or other means for counterbalancing so that when the rail is pushed to one side, a length of material will be pulled from one of the cassettes at the same time that a corresponding length of material retracts into the other cassette. In this way, the door system can have a door opening that ranges from providing full ventilation (i.e., the opening 302 is covered only with screen) to no ventilation (i.e., the opening 302 is covered with only transparent film). Exemplary screen materials that can be used with the embodiments described herein include materials such as aluminum, steel, fiberglass, woven fabric, combinations of these materials, and the like. Further, it is understood that references made herein to “glass panels” are intended to include sheets of transparent or semi-transparent materials instead of or in addition to glass, such as polycarbonate, polycarbonate resin thermoplastics (such as the material commercially available under the trade designation “Lexan”), clear laminates, and clear films, and the like.

The present invention has now been described with reference to several embodiments thereof. The entire disclosure of any patent or patent application identified herein is hereby incorporated by reference. The foregoing detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the structures described herein, but only by the structures described by the language of the claims and the equivalents of those structures.

1. A door system comprising:
a door frame comprising first and second sides spaced from each other, top and bottom edges spaced from each other and generally perpendicular to the first and second sides, a central opening defined by the first and second sides and the top and bottom edges, and a track system comprising a track positioned adjacent to at least one of the top and bottom edges of the frame;
a first panel comprising a first edge, the first panel moveably mounted to the track system of the door frame;
a second panel extending from the first edge of the first panel;
a first pocket at the first side of the door frame for containing a portion of the first panel; and
a second pocket at the second side of the door frame for containing the second panel;
wherein first panel is movable from the second side of the door frame toward the first side of the door frame to move a portion of the second panel from the second pocket.

2. The door system of claim 1, wherein the first panel comprises one of a transparent or a semi-transparent material.

3. The door system of claim 2, wherein the first panel comprises glass.

4. The door system of claim 1, wherein the second panel comprises a screen material.

5. The door system of claim 1, wherein the first panel is horizontally movable from the first side of the door frame toward the second side of the door frame to move the second panel toward the second pocket.

6. The door system of claim 1, further including a latch for locking the first panel relative to the door frame.

7. The door system of claim 1, further including a handle for moving the first panel relative to the first and second pockets.

8. The door system of claim 1, wherein at least one of the track system and the first edge of the first panel comprises a roller system.

9. A door system comprising:
a door frame comprising first and second sides spaced from each other, first and second horizontal edges spaced from each other and oriented generally perpendicular to the first and second sides, a central opening defined by the first and second sides and the first and second horizontal edges, and a track system comprising a track positioned adjacent to at least one of the first and second horizontal edges of the frame;
a first panel comprising a first edge, the first panel moveably mounted to the track system of the door frame;
a second panel extending from the first edge of the first panel;
a first pocket at the first horizontal edge of the door frame for containing a portion of the first panel; and
a second pocket at the second horizontal edge of the door frame for containing the second panel;
wherein first panel is movable from the second horizontal edge of the door frame toward the first horizontal edge of the door frame to move at least a portion of the second panel from the second pocket.

10. The door system of claim 9, wherein the first horizontal edge comprises a top edge of the door frame and the second horizontal edge comprises a bottom edge of the door frame.

11. The door system of claim 9, wherein the first horizontal edge comprises a bottom edge of the door frame and the second horizontal edge comprises a top edge of the door frame.

12. The door system of claim 9, wherein the first panel comprises glass.

13. The door system of claim 9, wherein the second panel comprises a screen material.

14. A door system comprising:
a door frame comprising first and second sides spaced from each other across a width of the frame, top and bottom edges spaced from each other across a height of the frame, and a central opening;
a first cassette comprising a retractable and extendible flexible screen member that is movable across one of the width and the height of the door frame.

15. The door system of claim 14, wherein a direction of retraction and extension of the screen member is generally perpendicular to a longitudinal axis of the cassette.

16. The door system of claim 15, wherein the direction of retraction and extension of the screen member is generally horizontal relative to the door frame.

17. The door system of claim 15, wherein the direction of retraction and extension of the screen member is generally vertical relative to the door frame.

18. The door system of claim 14, further comprising a glass panel positioned over at least a portion of the central opening.

19. The door system of claim 18, wherein the glass panel is removably mounted to the door frame.

20. The door system of claim 14, further comprising a second cassette comprising a retractable and extendible flexible material that is attached along one edge to a pull rail, wherein the flexible material is transparent or semi-transparent, and wherein the screen member is attached at one edge to the pull rail.
